(19) United States
(12) Patent Application Publication
(10) Pub. No.: US 2016/0091114 A1
(43) Pub. Date: Mar. 31, 2016

(54) IRRIGATION PIPE LAYING MACHINE

(71) Applicant: Kingman Farms, LLC, Las Vegas, CA (US)

(72) Inventors: Frank K. Weigand, La Canada, CA (US); James M. Rhodes, Las Vegas, NV (US); Daniel Leigh Coats, Alamo, CA (US); Jeffrey Gregg Anderson, Santa Clarita, CA (US); Arthur Derby Ahlstone, Ventura, CA (US); Alfredo Tello Besara, Jr., Oxnard, CA (US); Dirk Griffith, Las Vegas, NV (US)

(21) Appl. No.: 14/502,538

(22) Filed: Sep. 30, 2014

(51) Int. Cl. F16L 1/036

(52) U.S. Cl. CPC F16L 1/036

(57) ABSTRACT

An irrigation pipe laying machine for glued or gasketed piped is disclosed. The example pipe laying machine includes a platform including a first end and a second end. The pipe laying machine also includes a clamp configured to grip a portion of a bell end of an upstream pipe to prevent the upstream pipe from moving, a spigot end of the upstream pipe being connected to a second upstream pipe. The pipe laying machine further includes a plunger located adjacent to the second end of the platform and configured to push against a bell end of a downstream pipe causing a spigot end of the downstream pipe to connect to the bell end of the upstream pipe. The plunger is configured to push against the face of the bell end of the downstream pipe when the clamp grips the portion of the bell end of the upstream pipe.

### BACKGROUND

Underground irrigation piping has been in use since about the 1940s to deliver water to arid areas or reduce the effects of droughts and heat waves. Most commonly, underground irrigation pipes deliver water below ground from a well, reservoir, or other water source to one or more sprinklers located in a field. The installation of irrigation pipes has become more frequent with changes in climate reducing available ground water in many parts of the world, including the West and Midwest of the United States. Further, as the world's population increases, the use of irrigation pipes has extended farming to relatively dry areas to deliver water for crops and livestock.

Since about the 1950s, irrigation pipes have been made from polyvinyl chloride (“PVC”). The use of PVC enables irrigation pipe to be flexible during installation while maintaining strength to endure over time with minimal water leakage. While PVC is the most prevalent material, some current irrigation pipes are made from other types of polymers or plastics. Irrigation pipes may be connected together through a number of different methods. For instance, some pipes are configured to be glued together. In other instances, some pipes (i.e., gasketed PVC pipes) are configured to be connected together via an elastomeric radial seal. The gasketed PVC pipes generally require fewer assembly steps and tools (e.g., glue is not applied) compared to pipes that are glued together. Further, the use of the gasket (elastomeric radial seal) is more forgiving regarding installation because pipes may be adjusted after being connected together. In comparison, pipes glued together cannot be easily adjusted because the glue sets relatively quickly. Further gaskets enable pipes to bend at greater angles without compromising the seal between the pipes.

Just as irrigation pipes have been available for about 70 years, the methods for installing or laying the pipe in the ground have been in use for almost the same amount of time. Most installations involve a group of workers tasked with manually connecting the pipes together in a trench. First, a trench digging machine (e.g., a trench excavator) or workers dig a trench in the ground. The workers then place the pipe in the trench and serially connect the pipe together. For example, the workers start at one end, often at the water source and work downstream connecting the pipes together. Each downstream pipe is connected to an open end of an upstream pipe until all of the irrigation pipes have been connected. With gasketed pipe, to make the actual connection, one worker generally holds the upstream pipe in place while one or more workers slide a spigot end of the downstream pipe into a bell end of the upstream pipe, often using a crowbar or pick axe to provide leverage. The bell end of the upstream pipe is inserted up to a line or mark on the spigot end of the downstream pipe. This can be a grueling labor intensive process since each pipe may weigh 20 to 100 pounds, with typically hundreds of pipes needing to be connected per day of a project.

FIG. 1 shows an example diagram of commonly used gasketed irrigation pipes. The diagram includes an upstream pipe 102 that has a bell end 104 and a spigot end (not shown), which is connected to another upstream pipe (located further upstream toward the water source). The diagram also shows a downstream pipe 106 with a bell end (not shown) and a spigot end 108. The bell end 104 of the downstream pipe 106 is open (e.g., not connected to another pipe). The bell end 104 of the upstream pipe 102 includes a bell mouth 110 configured to connect to the spigot end 108 of the downstream pipe 106. To make the connection, workers apply a lubricant (or adhesive in instances where the pipes do not include a gasket) to a portion of the spigot end 108 and manually push the downstream pipe 106 such that the spigot end 108 enters and forms a connection with the bell mouth 110 of the bell end 104 of the upstream pipe 102. The resulting pipe joint is sealed by an elastomeric gasket, which is bonded into the inside diameter of the bell end 104. It should be noted that the elastomeric gasket is bonded into the inside diameter of the bell end for all the pipes during pipe manufacture.

A frequent issue with the connection of gasketed irrigation pipes is that the spigot end 108 may occasionally become over-inserted or under-inserted into the bell mouth 110. Over-inserting causes the spigot end 108 to extend deeper into the bell mouth 110 past a connection point, thereby increasing stress in the connection, particularly during thermal cycling or ground movement. The increased stress at the connection may cause the pipe to crack at the joint, which enables water to leak from the connection. Under-inserting irrigation pipes leads to gaps forming between the bell end 104 of the upstream pipe 102 and the spigot end 108 of the downstream pipe. Under-inserting irrigation pipes also increases the chances of the pipe ends 104 and 108 breaking apart. In either scenario, a great deal of water may be lost from a single misaligned or broken pipe joint. It should be noted that since the pipes are typically buried several feet under the ground after installation, locating a source of a leak, which may not occur until long after installation, is difficult and expensive.

A significant reason for over-inserted or under-inserted irrigation pipes is the manual labor involved in connecting the pipes. For instance, workers often connect the pipe in trenches, where there is not much room to maneuver. A typical trench is only slightly wider than the pipe it carries. Further, the pipe installation often occurs outdoors in hot and arid climates, which increases worker fatigue and the loss of concentration and focus. Additionally, with glued pipe, the adhesive used to bond or seal the connection is fast-setting, which is designed to prevent already connected downstream pipes from becoming over-inserted from the stress of connecting an upstream pipe. However, the fast-setting nature of the adhesive provides only one opportunity for the workers to make a proper connection. Otherwise an improperly set joint has to be cut apart and then a new pipe inserted. With gasketed pipe, to fix an improper connection, the workers have to use a great deal of force to separate the connected pipes. As one can appreciate, fixing an improper connection wastes time, energy, and ultimately money. For these reasons, workers generally disregard improper connections unless the over-insertion or under-insertion is severe.

To provide workers assistance making a proper connection, some irrigation pipe manufacturers apply a visual indicator 112 to the spigot end 108 of the pipe. In FIG. 1, the visual indicator 112 is a black line along a portion of a circumference of the spigot end 108. The visual indicator 112 specifies to what point the downstream pipe 106 is to be inserted into the bell end 104 of the upstream pipe 102. In other words, for a proper connection, the downstream pipe 106 is to be inserted into the into the bell mouth 110 of the downstream pipe 102 until an edge 114 of the bell mouth 110 nearly reaches or touches the visual indicator 112.

The visual indicator 112 may reduce the occurrences of over-insertion and under-insertion, however, it does not entirely eliminate the issue. The visual indicator 112 does not physically prevent over-insertion or under-insertion. Additionally, workers may disregard the visual indicator 112.

As an alternative to manual labor, some companies offer machines to connect and install irrigation pipe. For example, one known company offers a backhoe shovel attachment that is configured to grip irrigation pipe. While this machine is able to move the pipe with relative ease, it is a relatively slow process to properly position the backhoe arm to connect the downstream pipe 106 to the upstream pipe 102. Further, the operator has relatively little feedback (other than visual confirmation) regarding whether the pipes are over-inserted or under-inserted, even with use of the visual indicator 112. Moreover, the use of the backhoe arm attachment may connect the pipes with such force that causes further upstream pipe connections to break or become over-inserted.

Other known machines are configured to enable workers (or mechanical equipment) to connect irrigation pipe above a trench. These machines then allow the connected pipe to be lowed into the trench as the machines move downstream. However, as shown in the diagram 200 of FIG. 2, irrigation pipe experiences relatively high stress when bent above a certain angle. The diagram 200 shows that irrigation pipe lowered into a trench is bent above this angle at a longitudinal distance 202 (e.g., 20 to 30 feet from the top of a trench) before the pipe reaches the ground. The stress at this angle may disrupt or otherwise break pipes joints, resulting in water leakage. The stress may also cause over-inserted or under-inserted pipes to completely break apart. Further, while these known machines enable irrigation pipe to be connected above ground, these machines cannot regulate the over-insertion or under-insertion of irrigation pipes.

SUMMARY

The present disclosure provides a new and innovative irrigation pipe laying machine that solves at least some of the issues discussed above by including functionality to automatically and consistently make a proper connection between an upstream pipe and a downstream pipe with minimal effort by workers. The example pipe laying machine disclosed herein includes a rail that guides and gradually lowers irrigation pipe into a trench. This gradually lowering of the pipe along the rail prevents the pipe from bending at unacceptably large angles, thereby preserving the integrity of the joint. The pipe laying machine also includes a clamp configured to grasp an upstream pipe at a bell mouth of a bell end. The pipe laying machine further includes a plunger configured to push an open bell end of a downstream pipe causing the spigot end of the same downstream pipe to connect with the clamped bell end of the upstream pipe. The example plunger is configured to operate in conjunction with the clamp such that the upstream pipe is held in place on the rail while the plunger inserts the downstream pipe into the bell end of the upstream pipe.

After a connection has been made, the clamp is opened, the plunger is reset, and the pipe laying machine moves downstream causing the connected pipe to be gradually lowered into the trench via the rail. After the pipe laying machine has moved approximately the length of an irrigation pipe, another downstream pipe is loaded onto the rail and the process is repeated to connect the next downstream pipe to the newly connected upstream pipe (i.e., the previously connected downstream pipe. The disclosed pipe laying machine accordingly operates as a conveyor system that continuously connects and lowers irrigation pipe into a trench.

In an example embodiment, an example pipe laying machine includes a platform including a first end and a second end, the platform being configured to move relative to the ground. The pipe laying machine also includes a clamp located adjacent to the first end of the platform and configured to grip a portion of a bell end of an upstream pipe to prevent the upstream pipe from moving, a spigot end of the upstream pipe being connected to a second upstream pipe. The pipe laying machine further includes a plunger located adjacent to the second end of the platform and configured to push against a face of a bell end of a downstream pipe causing a spigot end of the downstream pipe to connect to the bell end of the upstream pipe. The example plunger is configured to push against the face at the bell end of the downstream pipe when the clamp grips the portion of the bell end of the upstream pipe.

In another example embodiment, a method of laying pipe includes moving a platform to a first position adjacent to a trench, the platform including a first end and a second end, the first position corresponding to a location where a clamp is adjacent to a portion of a bell end of an upstream pipe. The method also includes closing the clamp on the portion of the bell end of the upstream pipe to prevent movement of the upstream pipe. Conditioned on closing the clamp, the method includes moving a plunger from an initial position to push against an end face at a bell end of a downstream pipe causing a spigot end of the downstream pipe to connect to the bell end of the upstream pipe. After making the connection, the method further includes opening the clamp, returning the plunger to the initial position, and moving the platform to a second position downstream from the first position adjacent to the trench causing the connected upstream pipe and the downstream pipe to remain stationary relative to the ground while being lowered into the trench.

Additional features and advantages of the disclosed system, method, and apparatus are described in, and will be apparent from, the following Detailed Description and the Figures.

### BRIEF DESCRIPTION OF THE FIGURES

FIG. 1 shows an example diagram of widely used irrigation pipes.

FIG. 2 shows an example diagram of stress experienced by an unsupported irrigation pipe while being lowered into the ground.

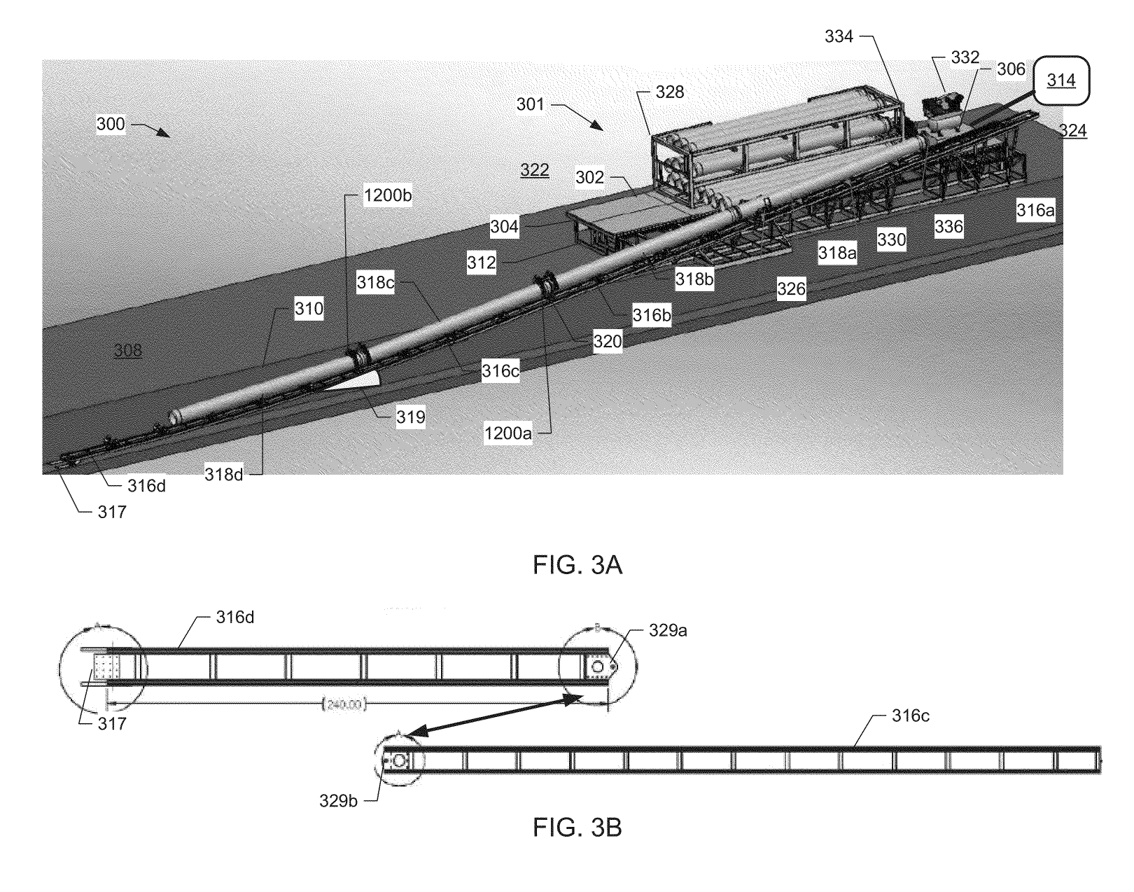

FIG. 3A shows a diagram of an example irrigation pipe laying environment including a pipe laying machine, according to an example embodiment of the present disclosure.

FIG. 3B shows a diagram of rails sections of FIG. 3A prior to connection, according to an example embodiment of the present disclosure.

FIG. 3C shows a top-perspective diagram and a side-perspective diagram of an alternative connection mechanism for the rail sections of FIGS. 3A and 3B, according to an example embodiment of the present disclosure.

FIG. 4 shows a diagram of an enlarged view of a pair of castors from the pipe laying machine of FIG. 3A, according to an example embodiment of the present disclosure.

FIG. 5 shows a front-side perspective view of the pipe laying machine of FIG. 3A, according to an example embodiment of the present disclosure.

FIG. 6 shows a diagram of a clamp of the pipe laying machine of FIGS. 3A and 5 in an open position, according to an example embodiment of the present disclosure.

FIG. 7 shows a diagram of the clamp of FIG. 6 in a closed position, according to an example embodiment of the present disclosure.

FIGS. 8 and 9 show example diagrams of an example plunger of the pipe laying machine of FIGS. 3A and 5, according to an example embodiment of the present disclosure.

FIGS. 10 and 11 show diagrams of example embodiments of an example magazine of the pipe laying machine of FIGS. 3A and 5, according to an example embodiment of the present disclosure.

FIGS. 12 and 13 show an example joint clamp, according to an embodiment of the present disclosure.

FIG. 14 illustrates a flow diagram showing an example procedure to connect and lay irrigation pipe, according to an example embodiment of the present disclosure.

### DETAILED DESCRIPTION

The present disclosure relates in general to a method and apparatus for laying irrigation pipe. The example method and apparatus use a conveyor system to connect irrigation pipe above ground on a platform that is aligned with a trench. The pipe is connected on a rail that extends from the platform into trench. The example method and apparatus use a clamp to hold an upstream pipe while using a plunger to push or otherwise connect a downstream pipe with the clamped upstream pipe. After making a connection, the example method and apparatus disclosed herein move the platform and rail downstream along the trench causing the stationary upstream and downstream pipe to be gradually lowered into the trench.

The example rail used by the method and apparatus disclosed herein reduces an angle at which the irrigation pipes bend while being inserted into the ground. The reduced angle of the irrigation pipe prevents a joint breaking or otherwise becoming misaligned, resulting in water leakage. Further, the use of the clamp in conjunction with the plunger provides an automated pipe connection mechanism that consistently and quickly makes proper connections between upstream and downstream pipes with minimal effort required by workers. The consistent pipe connections reduces (or eliminates) the number of connection fixes that occur. Further, the relatively low effort required by the workers enables the process to continue for long periods of time, thereby enabling significant amounts of irrigation pipe to be laid during a day. Moreover, the relatively automated process enables pipe to be connected faster (e.g., 15 to 40 seconds), thereby increasing productivity and reducing installation costs.

The example pipe laying machine of the example method and apparatus is configured to connect irrigation pipe ranging in diameter from 6 inches to 27 inches. It should be appreciated that the method and apparatus may also be used (with some modification) for irrigation pipe with a diameter that is less than 6 inches or greater than 27 inches. The spacing of castors, wheels, or rollers (e.g., sliders) on the rail may be adjusted based on the diameter of the pipe being used. The pipe laying machine may use pipe of varying lengths from a few feet to twenty or thirty feet in length. In some instances, different pipe magazines may be used based on the length of the pipe. Further, as disclosed herein, the irrigation pipe is made from PVC. In other embodiments, the irrigation pipe may be made from other materials such as polymers, plastic, rubber, metal, etc. Further, while reference is made specifically to irrigation pipe, the example pipe laying machine may be used to connect and lay pipes for other uses below or above ground. For example, the pipe laying machine may be used for laying utility pipe, pipes for transporting oil or natural gas, and/or pipes for shielding wires.

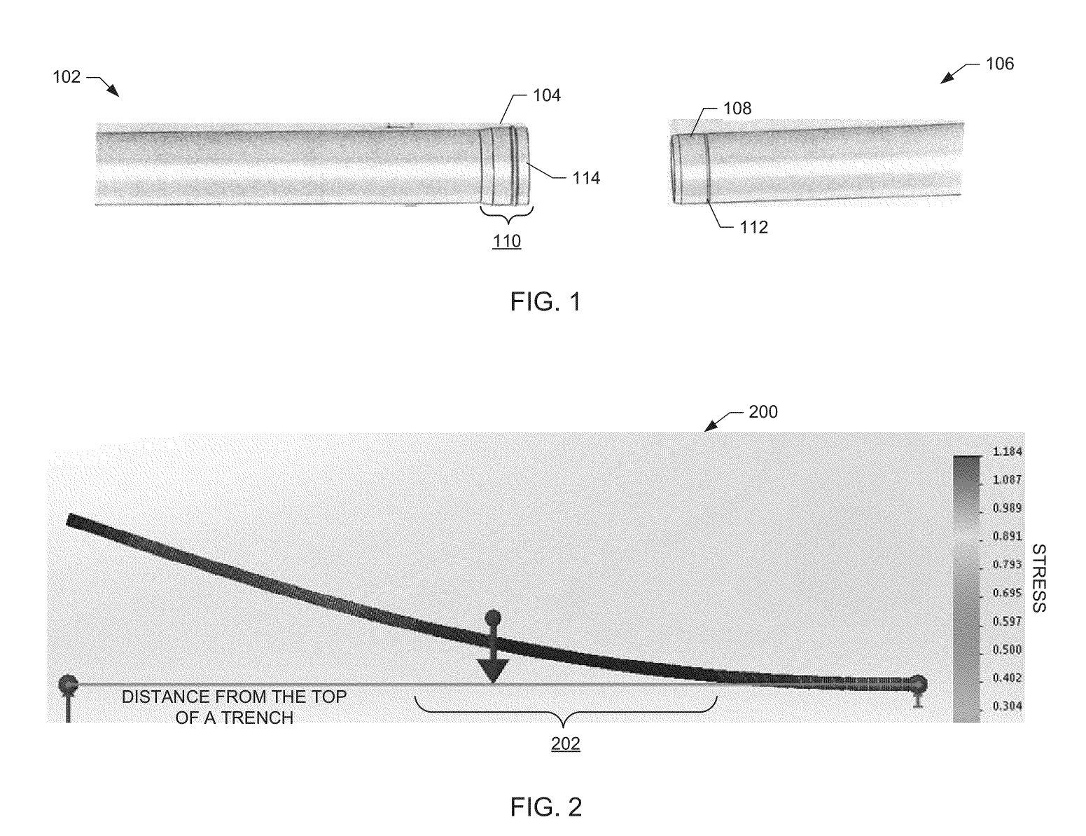

As discussed above, each pipe has two ends, a bell end and a spigot end. The bell end (e.g., the bell end 104 of the upstream pipe 102 of FIG. 1) is configured to have a bell mouth shape to accept the spigot end of an adjacent pipe (e.g., the spigot end 108 of the downstream pipe 106). The spigot end is configured to have, for example, an elastomeric seal to engage connection sections within the bell mouth of the bell end. In some instances, the connection of the elastomeric seal to the bell mouth is sufficient to create a secure water-tight pipe joint. In other instances, an adhesive may be applied to the spigot end and/or the bell end to secure and create a water-tight joint.

It should be appreciated that the example method and apparatus disclosed herein may also connect pipes having different shaped ends or other connection mechanisms. For example, the example method and apparatus may connect pipes secured together via joint sections, pipes connected via ring clamps, or pipes glued/welded together. Further, while the example method and apparatus are disclosed as pushing a spigot end of a downstream pipe into a bell end of an upstream pipe, in other embodiments, the example method and apparatus may push a bell end of a downstream pipe onto a spigot end of an upstream pipe.

Reference is made herein to upstream and downstream pipe. As discussed herein, upstream pipe refers to an irrigation pipe that has been connected to a chain of other irrigation pipes. An upstream pipe may be located on a rail of the pipe laying machine and/or within a trench. Also, as discussed herein downstream pipe refers to irrigation pipe that has yet to be connected or is in the process of being connected to an upstream pipe. The downstream pipe may be located on a rail during connection to an upstream pipe. The downstream pipe may also be located in a magazine on a pipe laying machine in queue to be connected.

### Irrigation Pipe Laying Environment

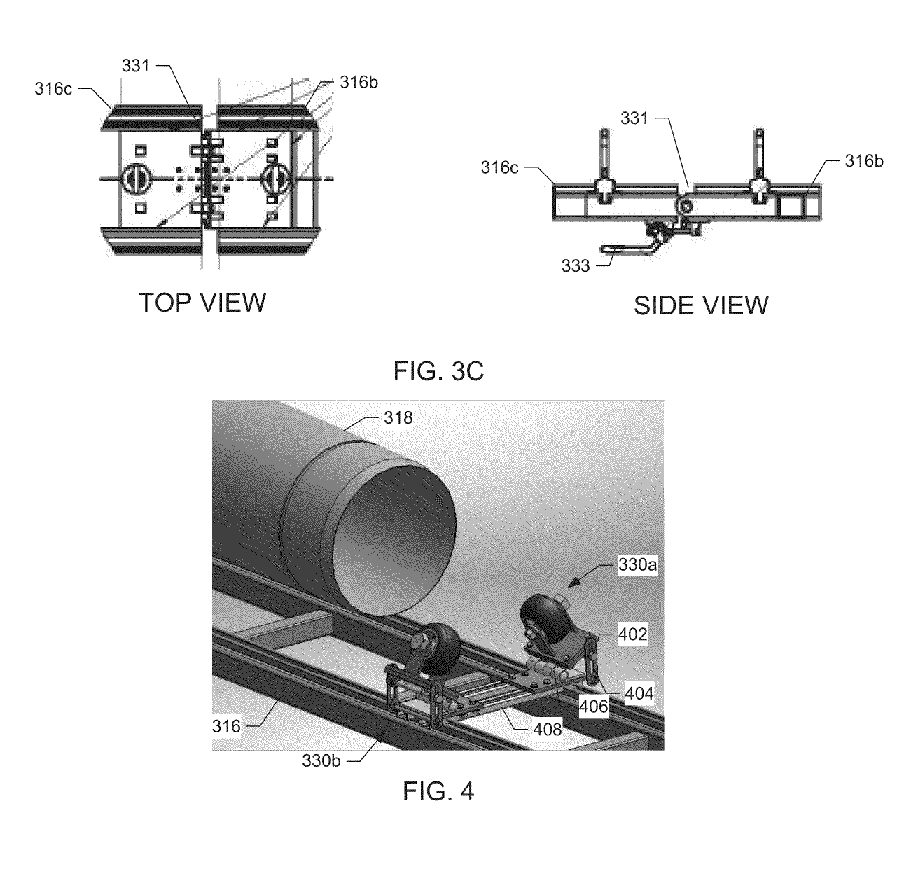

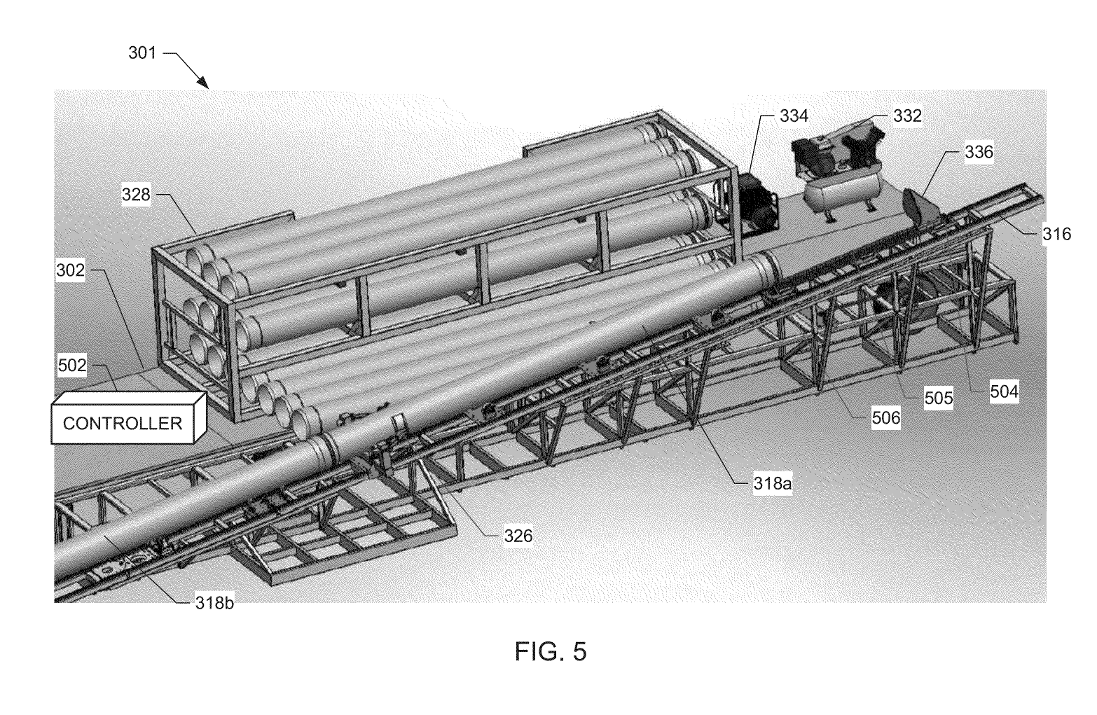

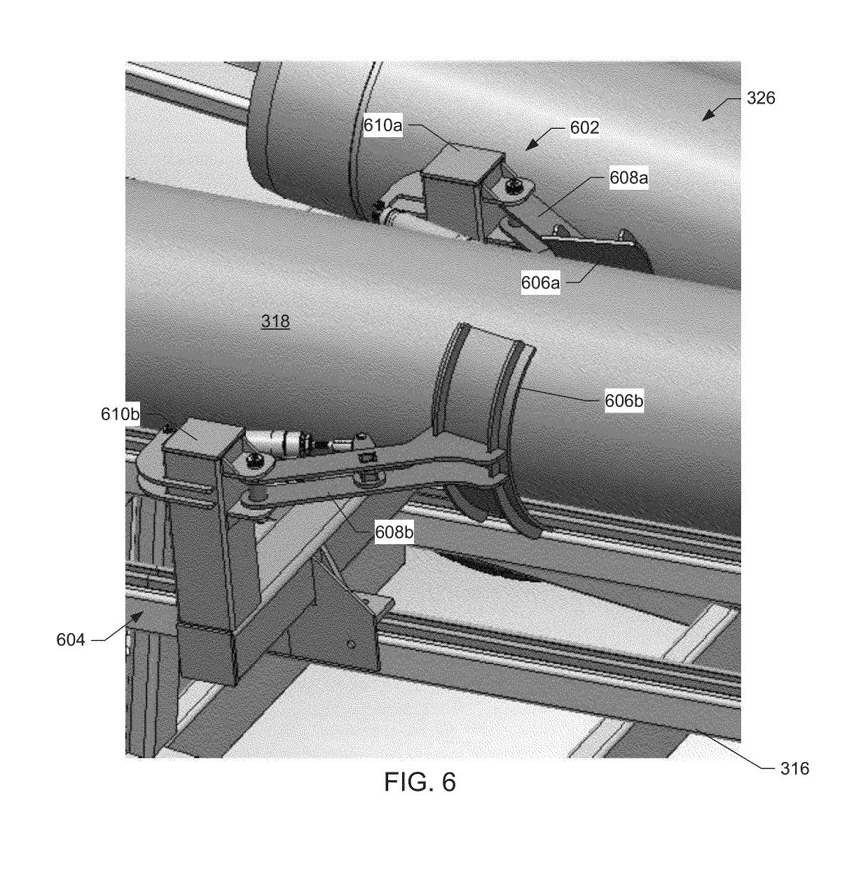

FIG. 3A shows a diagram of an example irrigation pipe laying environment 300 including a pipe laying machine 301. In this embodiment, the irrigation pipe laying machine 301 includes a platform 302 with a first end 304 and a second end 306. The example platform 302 is configured to move relative to ground 308, which includes a trench 310 (shown as being partially cut-away in FIG. 3). The platform 302 includes an undercarriage 312 that includes a support structure and wheels to enable the platform 302 to move over the ground 308. The platform 302 may include any type of wheels and/or be configured to pass over any type of terrain. In other embodiments, the undercarriage 312 may include a suspension system and/or a steering system.

In this embodiment, the trench 310 is formed by a trench digging machine or excavator prior to the platform 302 beginning to connect and lay irrigation pipe. The trench 310 is dimensioned based on a size of a shovel used to dig the trench 310. Generally, the trench 310 is just large enough to accommodate the irrigation pipe. In some embodiments, the platform 302 may be connected to a trench digging machine and/or be integrated with the functionality to dig the trench 310 while connecting and laying irrigation pipe.

The example platform 302 of FIG. 3A is pulled along the trench 310 by, for example, a tractor 314. In other embodiments, the tractor 314 may be replaced by a truck or other propulsion source. In yet other embodiments, the platform 302 may include functionality to be self-propelled. For example, the platform 302 could include an engine, transmission, and drivetrain to enable an operator to drive the platform 302 along the trench 310.

The example platform 302 of FIG. 3A also includes a rail 316 that is configured to support irrigation pipe 318. As shown in FIG. 3A, the rail 316 has a total length of about 150 feet. The rail 316 has a length of about 60 feet at the platform 302 and a length of about 90 feet within the trench 310. It should be appreciated that in other examples, the rail 316 may be longer or shorter depending, for example, on a length of the platform 302, the depth of the trench 310, and/or a slope angle 319 desired. As discussed below, the slope angle 319 is the angle formed by the rail 316 relative to a base or bottom of the trench 310. A longer rail 316 generally reduces the slope angle.

The example rail 316 includes a first section 316a (e.g., a first end) that is connected or integrated with the platform 302, a second section 316b connected to the first section 316a, a third section connected to the second section 316b, and a fourth section 316d (e.g., a second end) connected to the third section 316c. The second section of the rail 316b through the fourth section of the rail 316d is disposed within the trench 310. The end of the fourth section 316d may be connected to a skid plate 317 to reduce friction with the trench. The example rail 316 is configured with respect to the platform 302 to be aligned with the trench 310. The rail 316 is inclined at an angle to enable the irrigation pipe 318 to be gradually lowered into the trench 310 as the platform 302 moves relative to the ground 308. The slope angle 319 of the rail 316 is set so as to reduce stress of the irrigation pipe 318 (and especially the stress experienced by the pipe joints 320 while being lowered in to the trench 310) to an acceptable level, as determined by the pipe manufacturer.

The slope angle 319 shown in FIG. 3A is approximately 10 degrees. In other examples, the slope angle may vary between 2 to 15 degrees to reduce stress experienced by the irrigation pipe 318 being lowered into the trench 310. In some examples, the slope angle of the rail 316 may vary at different sections. For example the first section of the rail 316a may have a slope angle of 11 degrees while the fourth section of the rail 316d may have a slope angle of 7 degrees. The decrease in the slope angle gradually aligns the pipe 318 with the flat bottom profile of the trench 310 further reducing stress.

As shown in FIG. 3A, the rail 316 is positioned on a side of the platform 302 such that the platform 302 in conjunction with the rail 316 is cantilevered or suspended over the trench 310. In other embodiments, the rail 316 may be positioned in a center of the platform 302 to enable the platform 302 to straddle the trench 310. In some embodiments, the positioning of the rail 316 relative to the platform 302 may be configurable based on characteristics of the ground 308, the trench 310, and/or a diameter of the irrigation pipe 318.

The example platform 302 of FIG. 3A is pulled downstream from a first position 322 to a second position 324. At the first position 322, irrigation pipe 318a (e.g., a downstream pipe) is connected to the irrigation pipe 318b (e.g., an upstream pipe). As shown in FIG. 3A, the irrigation pipe 318b is connected to another upstream irrigation pipe 318c, which is connected to yet another upstream irrigation pipe 318d. After connecting irrigation pipes 318a and 318b, the platform 302 is moved to the second position 324, which is about one pipe-length from the first position 322. At the second position 324, a bell end of the irrigation pipe 318a is positioned to be adjacent to a clamp 326, enabling another downstream irrigation pipe to be loaded onto the rail 316 from a magazine 328.

It should be appreciated that the irrigation pipe 318 does not move laterally along the trench 310. The movement of the platform 302 and the rail 316 relative to the ground 308 causes the stationary irrigation pipe 318 to be gradually lowered into the trench 310. For instance, as the platform 302 moves to the second position 324 (downstream), the rail 316 also moves downstream. The irrigation pipe 318a is aligned with, for example, the first section of the rail 316a when the platform 302 is at the first position 322 and aligned with the second section of the rail 316b when the platform is at the second position 324. At the second position the irrigation pipe 318a is closer to a bottom of the trench 310. As the platform 302 and the rail 316 move further downstream, the irrigation pipe 318a drops lower into the trench 310 until it is completely separate from the rail 316. At this point, the irrigation pipe 318a rests on a floor, base, or bottom of the trench 310.

To prevent the irrigation pipe 318 from moving while the platform 302 moves, the example rail sections 316a to 316d are configured to include castors 330 (e.g., wheels, rollers, sliders, bowtie rollers, etc.) to enable the irrigation pipe 318 to remain stationary with respect to the moving platform 302. As shown in FIG. 3A, each pair of castors 330 is located about ten to fifteen feet from another pair of castors along the rail 316. The castors 330 may be adjusted with respect to a longitudinal positioning along the rail 316 to accommodate longer/shorter or heavier irrigation pipe. For example, the pairs of castors 330 may be moved closer together so that additional castors may be added to the rail 316.

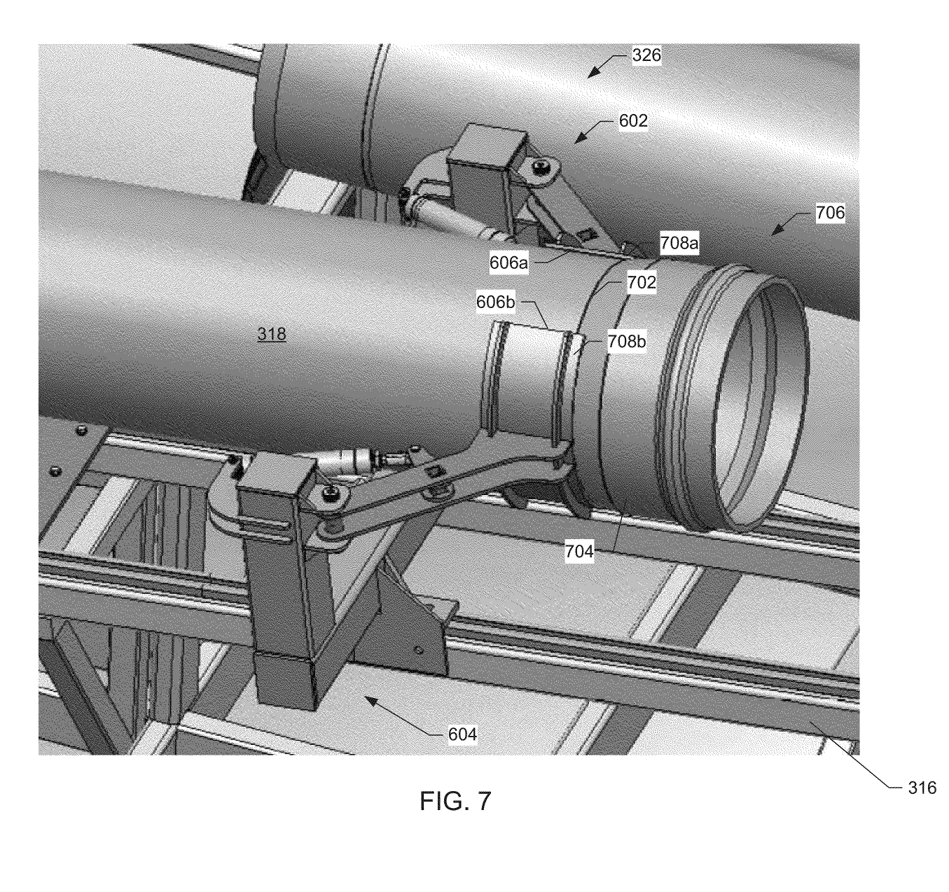

The castors 330, as shown in more detail in FIG. 4, are adjustable based on a diameter of the irrigation pipe 318. For example, FIG. 4 shows that each castor 330a and 330b includes a pin 402, an adjustment bar, 404, and a hinge 406. The removal of the pin 402 enables the castor 330a to be rotated via the hinge 406 and the slider bar 404 based on a diameter of the irrigation pipe 318. Additionally, each pair of the castors 330a and 330b is attached to the rail 316 via a support 408. The castors 330a and 330b may be slideably positioned along a length of the support 408 based on a diameter of the irrigation pipe 318. For instance, the castors 330a and 330b may be slide to a center of the rail 316 and the support 408 for relatively small irrigation pipe diameters. It should be appreciated that the adjustability of the castors 330a and 330b enables the rail 316 to be used for a wide range of irrigation pipes and/or other types of pipe.

Regarding rail connectivity, FIG. 3B shows a diagram of the rails sections 316c and 316d of FIG. 3A prior to connection. As discussed above, the fourth section of the rail 316d includes a skid plate 317 configured to reduce friction with the trench 310. The example rail section 316d also includes a connector member 329a configured to connect to a connection member 329b of rail section 316c. It should be appreciated that the third section of the rail 316c may be connected to the second section of the rail 316b and the second section of the rail 316b may be connected to the first section of the rail 316a through similar connection members.

The connector members 329a and 329b may be joined together by aligning a center hole of each of the connector members 329a and 329b and placing a pivot pin within the aligned holes. Such a configuration enables the fourth section of the rail 316d to pivot laterally with respect to the third section of the rail 316c. This lateral pivoting may compensate in instances when the platform 302 is misaligned with the trench 310. The use of the pivot pin also enables the section of the rail 316c and 316d to be easily disconnected. For example, at the end of a run, the rail 316d may be disconnected from the rail 316c by removing the pivot pin. The rail sections 316a, 316b, and 316c may then be moved to the next trench and connected to an awaiting rail section with skid plate. In other instances, the use of the pivot pin enables the fourth rail section 316d to be disconnected at the end of a run, lifted out of the trench 310, and reattached to the rail portion 316c above the trench 310 before the platform 302 is moved to the next trench.

FIG. 3C shows a top-perspective diagram and a side-perspective diagram of an alternative connection mechanism for the sections of the rail 316a to 316d of FIGS. 3A and 3B. In this embodiment, the rail sections 316a to 316d are connected together via a hinge 331. Each rail section 316a to 316d includes interlocking connectors held together by a rod to form the hinge 331. The hinge 331 enables the rail sections 316a to 316d to pivot vertically to enable, for instance, the rail sections 316a to 316d to be raised and lowered into a trench. One of the rail sections 316a to 316d may also be configured to pivot horizontally to enable the rail 316 to be aligned with a trench or moved outside of a trench. The hinge 331 may be locked into place by a lock 333, which is configured to prevent, for instance, the rail sections 316a to 316d from vertically pivoting during use.

Returning to FIG. 3A, the example platform 302 also includes a compressor 332, a pneumatic controller 334, and a plunger 336. The example compressor 332 is configured to provide compressed fluid to the pneumatic controller 334, which provides pneumatic control (e.g., air or liquid) for the clamp 326 and/or the plunger 336. The platform 302 may also include a generator (not shown) to provide electricity to the compressor 332, the pneumatic controller 334, and/or any other control functionality on the platform 302.

In addition to supporting the rail 316, the magazine 328, the compressor 332, and the pneumatic controller 334, the example platform 302 is also configured to provide a work area. For instance, the first end 304 of the platform 302 may include enough space to enable workers to cut pipe (e.g., remove a bell end of a pipe to accommodate a fitting) and/or install fittings such as Tees, elbows, reducers, etc. typical for an irrigation system. The fittings may be connected to the upstream irrigation pipe 318b via the clamp 326 and/or plunger 336 and gradually lowered into the trench 310 via the rail 316. Alternatively, the fittings may be glued to the upstream pipe 318b.

### Pipe Laying Machine Control

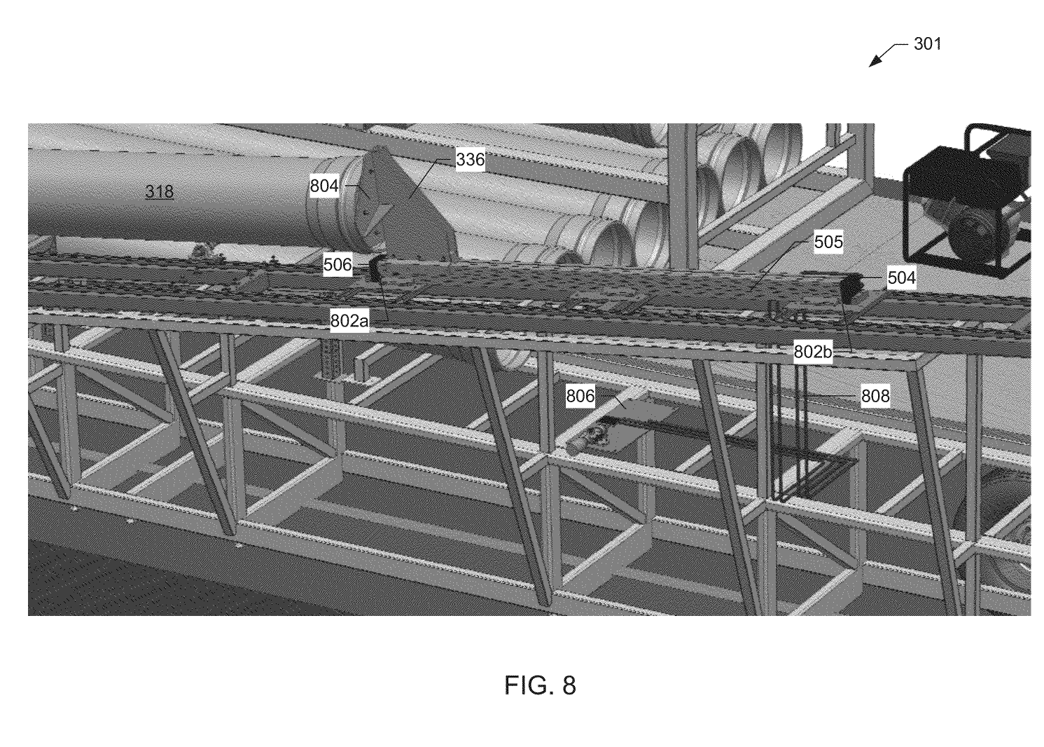

FIG. 5 shows a front-side perspective view of the pipe laying machine 301 of FIG. 3A, according to an example embodiment of the present disclosure. In this embodiment, the pipe laying machine 301 includes a controller 502 that controls the clamp 326 and the plunger 336. The example controller 502 provides control signals to the pneumatic controller 334, which positions valves that actuate the clamp 326 and the plunger 336. The example controller 502 may also include a communication interface to enable communications with the tractor 314 and/or the Internet.

The controller 502 is configured to open/close the clamp 326 and to engage/disengage the plunger 336. As discussed herein, opening the clamp 326 refers to causing the clamp 326 to move away and release a grip on the irrigation pipe 318. Closing the clamp 326 refers to moving the clamp 326 toward and gripping the irrigation pipe 318. Further, as discussed herein, engaging the plunger 336 refers to moving the plunger 336 from a first end 504 of a track 505 to a second end 506 of the track 505 causing the downstream pipe 318a to connect to the upstream pipe 318b. Disengaging the plunger 336 refers to moving the plunger 336 from the second end 506 of the track 505 to the first end 504 of the track 505 to enable another downstream pipe to be placed on the rail 316 (as shown in FIG. 5).

As discussed in more detail below, the controller 502 is configured to control the opening/closing of the clamp 326. For example, after connecting the downstream pipe 318a to the upstream pipe 318b, the controller 502 is configured to open the clamp 326, as shown in FIG. 5. The controller 502 may also be configured to inform an operator of the tractor 314 that it is safe to begin moving. Alternatively, sensors located on the rail 316 may detect the pipes 318a and 318b are connected and send a signal to the controller 502 and/or directly to the tractor 314. The controller 502 and/or sensors may provide an audio indication or may illuminate a light (e.g., a green light) in the tractor 314. Additionally or alternatively, the controller 502 and/or sensors may cause the tractor 314 to move or disengaging a brake preventing the tractor 314 from moving. In some embodiments, the controller 502 and/or the sensors may send the movement signal to the tractor 314 responsive to detecting the opening of the clamp 326.

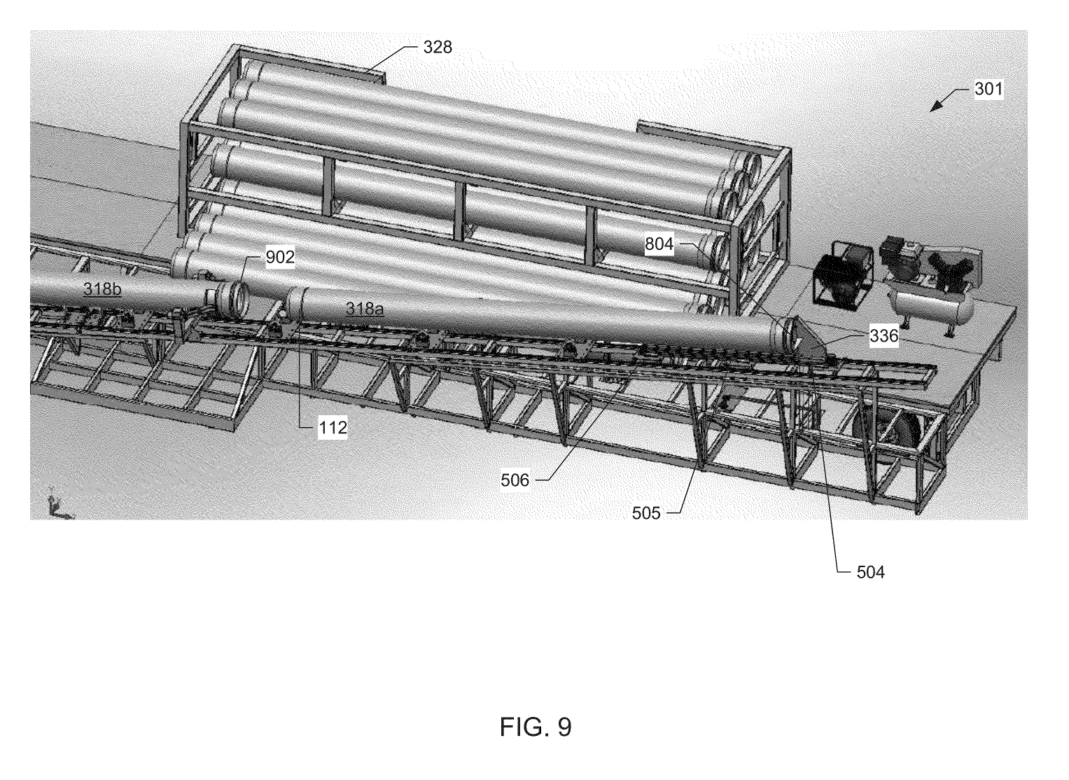

FIG. 6 shows a diagram of the clamp 326 in an open position as the platform 302 and the rail 316 move downstream relative to the irrigation pipe 318. As shown in FIG. 6, the clamp 326 includes a first clamp 602 and a second clamp 604. The first clamp 602 is configured to engage a first side of the irrigation pipe 318 and the second clamp 604 is configured to engage a second side of the irrigation pipe 318. It should be appreciated that other embodiments may use as few as one clamp and as many as four or five clamps. The first clamp 602 is configured to operate in tandem with the second clamp 604 so that opening and closing is performed substantially at the same time.

Each of the first and second clamps 602 and 604 includes a respective clamp face 606a and 606b configured to grip the irrigation pipe 318. The clamp face 606 is shaped to accommodate the exterior surface of the irrigation pipe 318. In some examples, an interior portion of the clamp face 606 may be smooth (e.g., include a smooth rubber material) to enable the irrigation pipe 318 to move through the clamp 326 until the clamp 326 contacts an edge of a bell mouth of the irrigation pipe 318. Alternatively, the interior portion of the clamp face 606 may include small spikes (or serrated teeth) to provide an improved grip on the irrigation pipe 318. It should be appreciated that the spikes grip the PVC exterior of the irrigation pipe 318 and/or pierce a surface of the irrigation pipe 318 without penetrating or cracking the pipe. The small spikes may provide additional leverage or grip when the irrigation pipe 318 is wet, dirty, or otherwise slippery.

The first and second clamps 602 and 604 also include respective clamp arms 608a and 608b connected to clamp actuators 610a and 610b. The example clamp arm 608 is configured to move the clamp face 606 to and away from the irrigation pipe 318. The arm 608 may be removable to enable different sized clamp faces to be attached to the pipe laying machine 301 based on a diameter of the irrigation pipe 318. The example clamp actuator 610 is configured to rotate the clamp arm 608, thereby moving the clamp face 606 into an opened or closed position. The clamp actuator 610 may be pneumatically controlled, via the pneumatic controller 334.

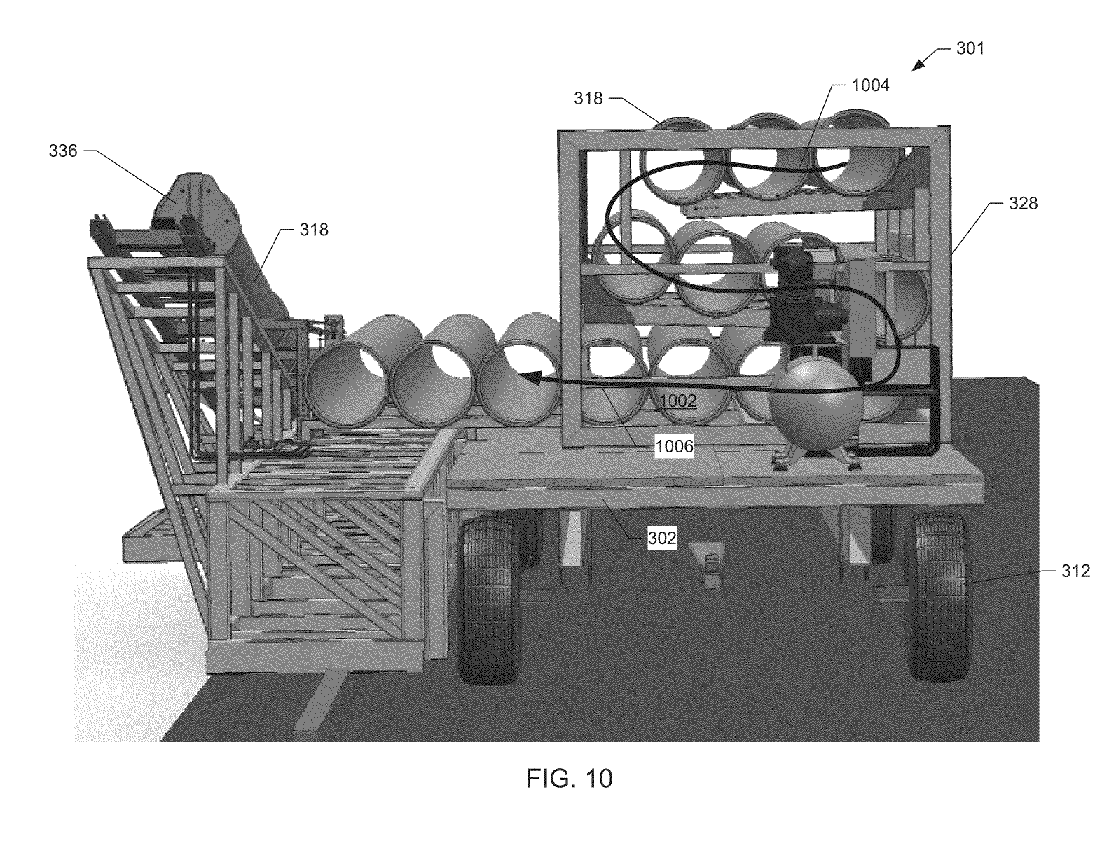

The example clamp 326 may be closed by the controller 502 when the tractor 314 is stopped and the clamp face 606 is aligned with an edge 702 of a bell mouth 704 of a bell end 706 of the irrigation pipe 318, as shown in FIG. 7. In some instances, the controller 502 may prevent the clamp 326 from being closed until the tractor 314 is stopped. The operator may use the controller 502 to send a verbal message to an operator of the tractor 314. Alternatively, the controller 502 may cause a light (e.g., a red light) to illuminate within the tractor 314. In yet other examples, the controller 502 may actually send instructions causing the tractor 314 to stop.

After the tractor 314 is stopped, the controller 502 is configured to close the clamp 326. As shown in FIG. 7, the clamp 326 is closed near the edge 702 of the bell mouth 704. Closing the clamp 326 at the bell mouth 704 prevents the irrigation pipe 318 from sliding upstream on the rail 316 as a result of the force from connecting a downstream pipe. In this embodiment, the clamp face 606 is specifically shaped so that an outer edge 708 of the clamp face 606 makes adequate contact with the edge 702 of the bell mouth 704.

After the clamp 326 is closed, the controller 502 is configured to actuate the plunger 336. In some instances, the controller 502 of FIG. 5 is configured to prevent the plunger 336 from moving from the first end 504 until the clamp 326 is closed. Such a configuration prevents a downstream pipe from being inserted into an upstream pipe before the upstream pipe is secure. The controller 502 is configured to engage the plunger 336 after a downstream pipe is loaded onto the rail 316 from the magazine 328. In some instances, the rail 316 may include a pressure sensor to detect when the new downstream pipe 318 has been loaded onto the rail 316. The controller 502 may use the feedback from the pressure sensor to prevent the plunger 336 from engaging the upstream pipe until the downstream pipe is loaded on the rail 316.

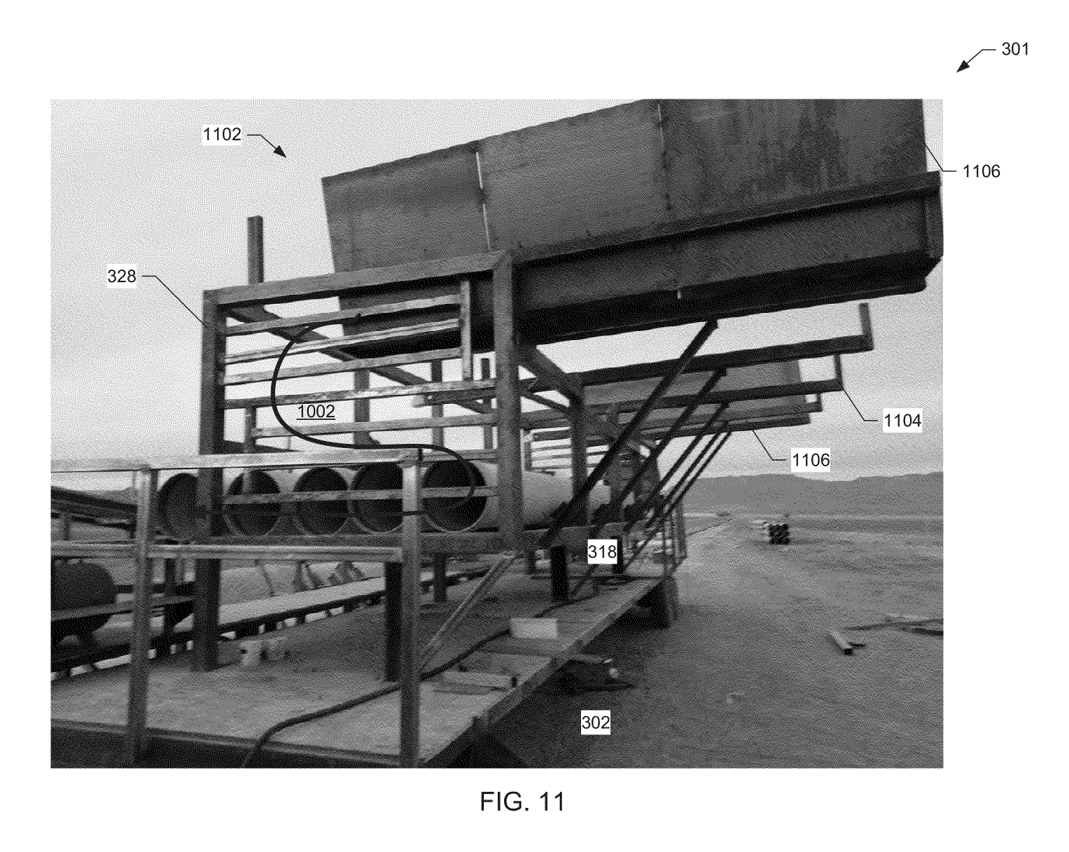

FIGS. 8 and 9 show example diagrams of the plunger 336 of FIGS. 3A and 5. The example plunger 336 is connected to the rail 316 via the track 505 including the first end 504 and the second end 506. The track 505 may be adjustable relative to the rail 316 based on, for example, a length of irrigation pipe to be connected. Further, the track 505 may include stoppers 802 to restrict movement of the plunger 336 along the track 802. For example, a first stopper 802a may be added to the second end 506 to prevent the plunger 336 from over-inserting irrigation pipe. A second stopper 802b may be added to the first end 504 to reduce a distance the plunger 336 has to move for shorter irrigation pipe.

The example plunger 336 includes a plunger face 804 configured to contact a face of an end (e.g., a bell end) of a downstream pipe. The plunger face 804 is dimensioned to engage substantially the entire circumference of the pipe end face to evenly apply pressure to the irrigation pipe 318. The plunger face 804 may be replaced with a larger or smaller face depending, for example, on a diameter of the irrigation pipe 318.

The example plunger 336 is controlled via the pneumatic controller 334 and/or the controller 502. For instance, to place the plunger 336 against a bell end of a downstream pipe, an operator may depress a plunger control button (e.g., a pusher foot valve), which causes the controller 502 to instruct the pneumatic controller 334 to apply fluid pressure to a plunger controller 806. The example plunger controller 806 amplifies the applied pressure within pneumatic lines 808, causing the plunger 336 to move upstream along the track 505. The controller 502 continues to cause the plunger 336 to move until an operator sees that the pipe is inserted up to the visual indicator 112 and accordingly releases the button. The plunger 336 may also stop moving when it reaches the second end 506 of the track 505 (or stopper 802a).

The example track 505 may also include a spring (not shown) that returns the plunger 336 to the first end 504 when the pneumatic pressure is removed. For example, an operator may release the plunger control button, which causes the controller 502 to stop the pneumatic controller 534 from applying pressure to the pneumatic lines 808. The pneumatic controller 534 may also cause the plunger controller 806 to bleed the pneumatic lines 808, further reducing pressure. The spring pushes the plunger 336 to the first end 504 after the pressure within the pneumatic lines 808 is reduced. Alternatively, the plunger controller 806 may apply pneumatic pressure to the second end 506 of the track 505 while bleeding pressure applied at the first end 504 to cause the plunger 336 to return to the first end 504.

FIG. 9 shows a diagram of the downstream pipe 318a being connected to the upstream pipe 318b. To make the connection, the plunger 336 pushes a face of a bell end of the downstream pipe 318a causing the spigot end of the downstream pipe 318a to enter a bell mouth of the upstream pipe 318b. The plunger 336 works in conjunction with the clamp 326 to make the connection without affecting any other upstream pipes (e.g., without causing further upstream pipes to become over-inserted or overstressing joints of connected upstream pipes). The plunger 336 continues to push the downstream pipe 318a until a leading edge 902 of a bell mouth of the upstream pipe 318b contacts or is adjacent to a visual indicator (e.g., the visual indicator 112 of FIG. 1) on the downstream pipe 318a. An operator may release the plunger control button when the leading edge 902 of the bell mouth reaches the visual indicator 112.

It should be appreciated that the pipe laying machine 301 shown in FIG. 9 enables irrigation pipe to be connected together automatically with minimal effort by an operator. As such, the operator is better able to control the operation to ensure the pipes are properly connected. Further, the plunger 336 in conjunction with the track 505 (and/or sensors, the controller 502, an operator, etc.) helps ensure that the downstream pipe 318a is not over-inserted, under-inserted, or misaligned, thereby providing consistent proper irrigation pipe connections.

As discussed, the use of the rail 316 in conjunction with the plunger 336 and the clamp 326 provides a conveyor system for connecting and laying irrigation pipe with consistent and proper joint alignment. Generally, it takes about 15 to 20 seconds to i) close the clamp 326, ii) apply adhesive/lubricant (if needed), iii) move the plunger 336 to connect a downstream pipe to an upstream pipe, and iv) open the clamp 326. Further, it takes about 20 to 30 seconds to move the pipe laying machine 301 to the next downstream position and load the next downstream pipe onto the rail 316. Accordingly, the example pipe laying machine 301 may connect and lay approximately 70 pipes an hour or 700 pipes during the course of a ten hour work day. In other words, the example pipe laying machine enables about 14,000 feet (i.e., 2.6 miles) of irrigation pipe (assuming irrigation pipe with a 20 foot length) to be connected and laid per day.

### Pipe Laying Supply

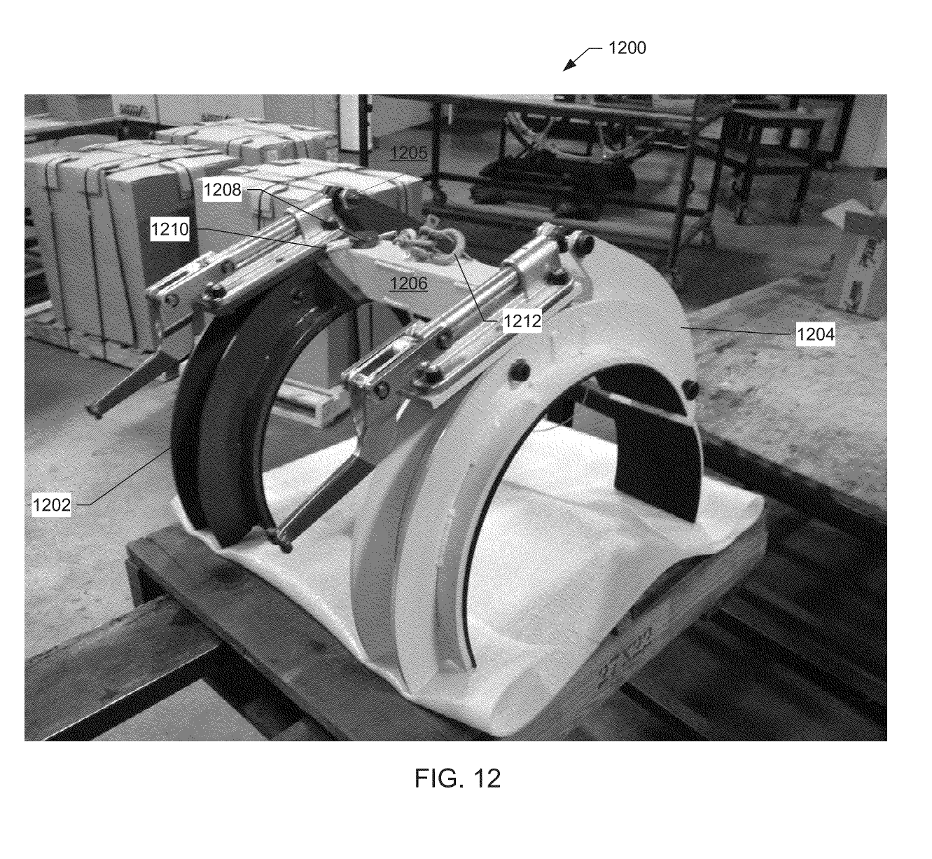

FIGS. 10 and 11 show diagrams of example embodiments of the magazine 328 of FIGS. 3A and 5. The example magazine 328 is configured to form a channel 1002 to consecutively align the irrigation pipes 318 before they are loaded onto the rail 316. The channel 1002 has a first end 1004 from which the irrigation pipes 318 are added by, for example, a forklift The channel 1002 also has a second end 1006 from which the irrigation pipes 318 exit and are made available to one or more operators to place onto the rail 316. The example channel 1002 within the magazine 328 is formed to have a sloped S-shape to enable the irrigation pipes 318 to be continuously gravity-fed. While the magazine 328 is shown as having three layers of the irrigation pipes 318, in other examples the magazine may have additional or fewer layers.

As shown in FIG. 10, the magazine 328 outputs the irrigation pipe 318 onto a top layer of the platform 302. An operator (or two operators) lifts the irrigation pipe 318 onto the rail 316 when the plunger 336 is in the disengaged position. However, in other examples, the magazine 328 may be configured to dispense the irrigation pipes 318 directly onto the rail 316. For example, the magazine 328 may output the irrigation pipes 318 directly above or directly adjacent to the rail 316. In these embodiments the magazine 328 may include an escapement mechanism that prevents the irrigation pipe 318 from entering the rail 316 (or rolling onto the platform 302) until the plunger 336 is moved into the disengaged position.

FIG. 11 shows a diagram of a funnel 1102, which may be used to order or otherwise consecutively align the irrigation pipes 318 prior to entering the channel 1002 of the magazine 328. Generally, forklift operators have a difficult time unloading irrigation pipe from a truck onto the relatively narrow channel 1002. The example funnel 1102 enables the irrigation pipes 318 to be placed at a first end 1104 by a forklift. A slope of the funnel 1102 causes the irrigation pipes 318 to roll downward into the channel 1002 one-at-a-time. The sloped sides 1106 of the funnel 1102 also align the irrigation pipes 318 with a width of the channel 1002 of the magazine 328. It should be appreciated that the irrigation pipes 318 are arranged prior to being loaded in the funnel 1102 so that the spigot ends and bell ends of the pipes all face the same direction.

### Joint Clamp

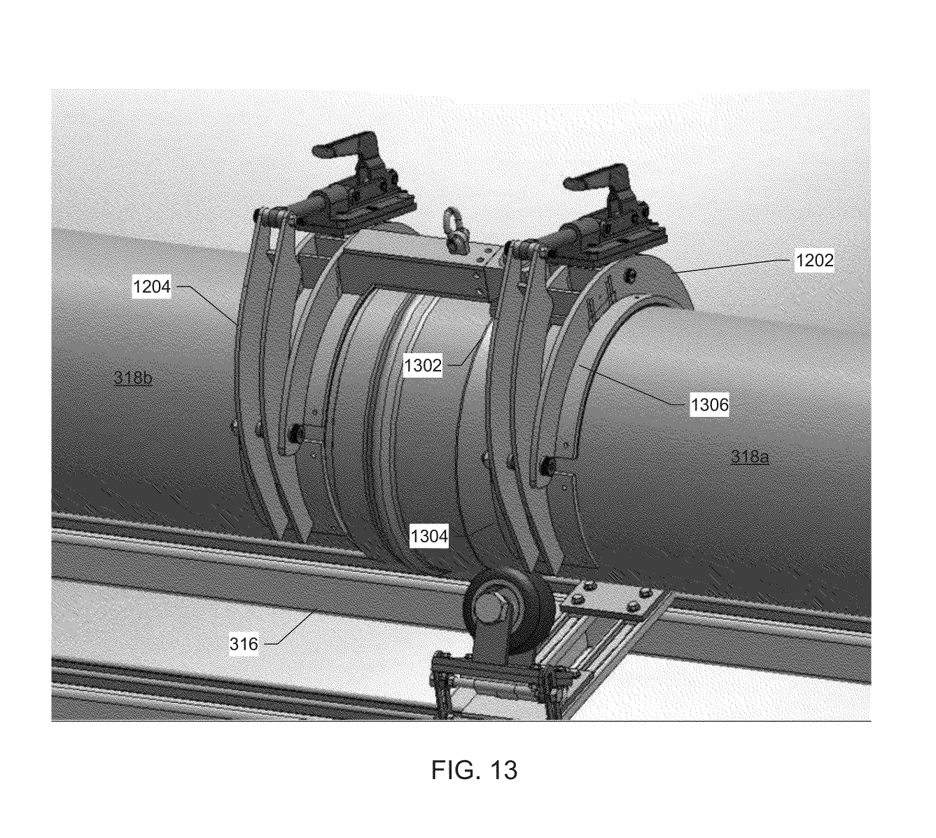

FIGS. 12 and 13 show an example joint clamp 1200, according to an embodiment of the present disclosure. As discussed above, the joints between irrigation pipes may become stressed while the pipes are being lowered into a trench. While the example rail 316 is configured to reduce or minimize joint stress, the example joint clamp 1200 may also be used to reinforce the joint between irrigation pipes to reduce stress and maintain proper alignment. FIG. 3 shows a first joint clamp 1200a connecting irrigation pipes 318b and 318c and a second joint clamp 1200b connecting irrigation pipes 318c and 318d. As shown in FIG. 12, the example joint clamp 1200 includes a first joint clamp half 1202 and a second joint clamp half 1204.

Each of the halves 1202 and 1204 of FIG. 12 includes push/pull toggle clamps 1205 to easily open/close the respective joint clamp halves 1202 and 1204. The joint clamp halves 1202 and 1204 are removeably connected together via a connector section 1206, a tab 1208, and a key 1210. The connector section 1206 is integrated with or otherwise permanently connected to the joint clamp half 1204. The tab 1208 is integrated with or otherwise connected to the other joint clamp half 1202. To connect the halves 1202 and 1204 together, the tab 1208 is placed through a hole in the connector section 1206 enabling a top of the tab 1208 to emerge from the hole. The key 1210 is inserted into a hole within the tab 1208 to secure the two halves 1202 and 1204 together. It should be appreciated that in other examples, the joint clamp halves 1202 and 1204 may be connected via other components. For example, each of the joint clamp halves 1202 and 1204 may include connector sections that are locked together via a clamp or a hinge.

During use, the joint clamp 1200 is initially separated into the two joint clamp halves 1202 and 1204. As shown in FIG. 13, the joint clamp half 1202 is placed (e.g., closed) adjacent to a visual indicator 1302 on a spigot end of the downstream pipe 318a. The joint clamp half 1202 is positioned such that an inside edge 1304 of a clamp face 1306 is downstream and adjacent to the visual indicator 1302. This configuration prevents the downstream pipe 318a from being over-inserted past the visual indicator 1302.

As shown in FIGS. 12 and 13, the joint clamp half 1204 is placed on the upstream pipe after the downstream pipe and upstream pipes are connected and the clamp 326 is opened. The joint half clamp 1204 is placed where the clamp 326 was located (i.e., at the edge 702 of the bell mouth 704 of the bell end 706 of FIG. 7). The joint clamp half 1204 is aligned or rotated so that the hole within the connector section 1206 is positioned to engaged the tab 1208 of the already closed joint clamp half 1202. The key 1210 is placed in the tab 1208 after the connector section 1206 is connected to the tab 1208. At this point, the joint clamp halves 1202 and 1204 are connected together across the joint of the upstream and downstream pipes, thereby securing the connected pipes. The joint clamp 1200 remains connected at the pipe joint until the pipes reach the bottom of the trench 310 at the end of the rail 316. The joint clamp 1200 may be removed by opening the push/pull toggle clamps 1205. The joint clamp 1200 may then be returned to the platform 302 and separated into the halves 1202 and 1204 for the next joint installation. Alternatively, the joint clamp 1200 may be attached to the already connected upstream and downstream pipes after the clamp 326 is opened and/or after the platform 302 begins moving downstream.

In some embodiments, the joint clamp 1200 may include a connector 1212, which is connected via a chain or rope to the platform 302. The connector 1212 enables the joint clamp 1200 to be returned to the platform 302 after being removed from a joint. An operator (or mechanical reel) may pull the chain or rope back toward the platform 302 causing the joint clamp 1200 to be pulled up from the trench 310 onto the platform 302. In some embodiments, the chain or rope may include a pneumatic pressure line. In these embodiments, an operator may remotely disconnect the joint clamp 1200 from a joint and cause the joint clamp 1200 to be reeled back to the platform 302. It should be appreciated that multiple joint clamps 1200 may be used (as shown in FIG. 3) and recycled in this manner to further expedite pipe laying production.

### Failsafe Embodiments

The example pipe laying machine 301 of FIGS. 3A to 11 may include one or more failsafe mechanisms to further prevent irrigation pipe joints from breaking or becoming overly stressed. As discussed above in conjunction with FIG. 3A, the example pipe laying machine 301 includes a platform 302 pulled by a tractor 314. The driver of the tractor 314 and an operator of the clamp 326 work in tandem to ensure that the platform 302 is stationary before an upstream pipe is clamped. Otherwise, the platform 302 may pull a clamped upstream pipe downstream, breaking already formed upstream joints. In some instances, the controller 502 may operate in conjunction with a camera and transmit a video feed to an operator of the tractor 314. The operator may view the video to determine when it is safe to move (e.g., when the clamp 326 is open). The operator may also view the video to determine when to stop moving the tractor 314 (e.g., when a bell mouth of an upstream pipe is aligned with the clamp 326).

In other embodiments, the controller 502 may be in communication with a brake system on the undercarriage 312 of the platform 302 or the tractor 314. The controller 502 may cause the brakes to be applied when (or immediately before) the clamp 326 contacts a bell mouth of the upstream pipe. The controller 502 may also cause one or more lights to illuminate within a driver compartment of the tractor 314 to indicate whether the clamp 326 is closed.

In some instances, the controller 502 may operate in conjunction with a vision system and/or other sensors to align the clamp 326 with a bell mouth of an upstream pipe. For example, the controller 502 may begin applying the brake to the platform 302 (and/or cause the tractor 314 to disengage from a drivetrain) when the clamp 326 is close to the bell mouth. This configuration enables an operator to drive the platform 302 while enabling the controller 502 to determine the precise location to stop. In yet alternative embodiments, the clamp 326 may be moveable along a portion of the rail 316 to enable an operator to make adjustments so the clamp 326 closes at the proper location on the bell mouth of the upstream pipe. In some instances, the controller 502 may cause the clamp 326 to move along the rail 316 to the proper position.

### Automated Pipe Laying Machine Embodiment

The example pipe laying machine 301 of FIGS. 3A to 11 was discussed in conjunction with reference to operators. For instance, an operator drives the tractor 314, an operator controls the clamp 326 and the plunger 336, one or more operators load an irrigation pipe onto the rail 316, and one or more operators installs and removes the joint clamp 1200. However, some or all of these operators may be replaced by automation. For example, the tractor 314 may be driven by, for example, the controller 502 using Global Positioning System (“GPS”) coordinates to steer. The controller 502 may also use a vision system to ensure the rail 316 is properly aligned with the trench 310 by steering the tractor 314 in the appropriate direction.

Moreover, as discussed, the magazine 328 may be configured to output downstream pipes when the plunger 336 is in the retracted or disengaged position. The controller 502 may cause the joint clamp half 1202 to be connected to the downstream pipe. The controller 502 may also cause the inside of the bell end of the upstream pipe and the outside of the spigot end of the downstream pipe to be cleaned. The controller 502 may also cause lubricant and adhesive (when necessary) to be applied to the outside of the spigot end of the downstream pipe.

Additionally, the controller 502 may be connected to a vision system that senses when a bell mouth of a bell end of an irrigation pipe is aligned with the clamp 336. Conditioned on aligning the clamp 336 with the bell mouth, the controller 502 may cause the tractor 314 (or otherwise the self-propelled platform 302) to stop, cause the clamp 326 to close, and cause the plunger 336 to push the spigot end of the downstream pipe into the bell end of the upstream pipe. The vision system may also determine when a leading edge of the bell mouth has reached a visual indicator on the downstream pipe. Responsive to making a connection (e.g., when the bell mouth of the upstream pipe reaches the visual indicator on the downstream pipe), the controller 502 may cause the clamp 328 to open, cause the joint clamp half 1204 to be closed on at the spigot end of the upstream pipe, cause the joint clamp halves 1202 and 1204 to be connected, and cause the plunger 336 to be returned to the first end 504 while causing the tractor 314 to move the platform 302 to the next position. The controller 502 may also be connected to sensors on the magazine 328 to sense when a supply of irrigation pipes is low and request additional pipes.

### Flowchart of the Example Process

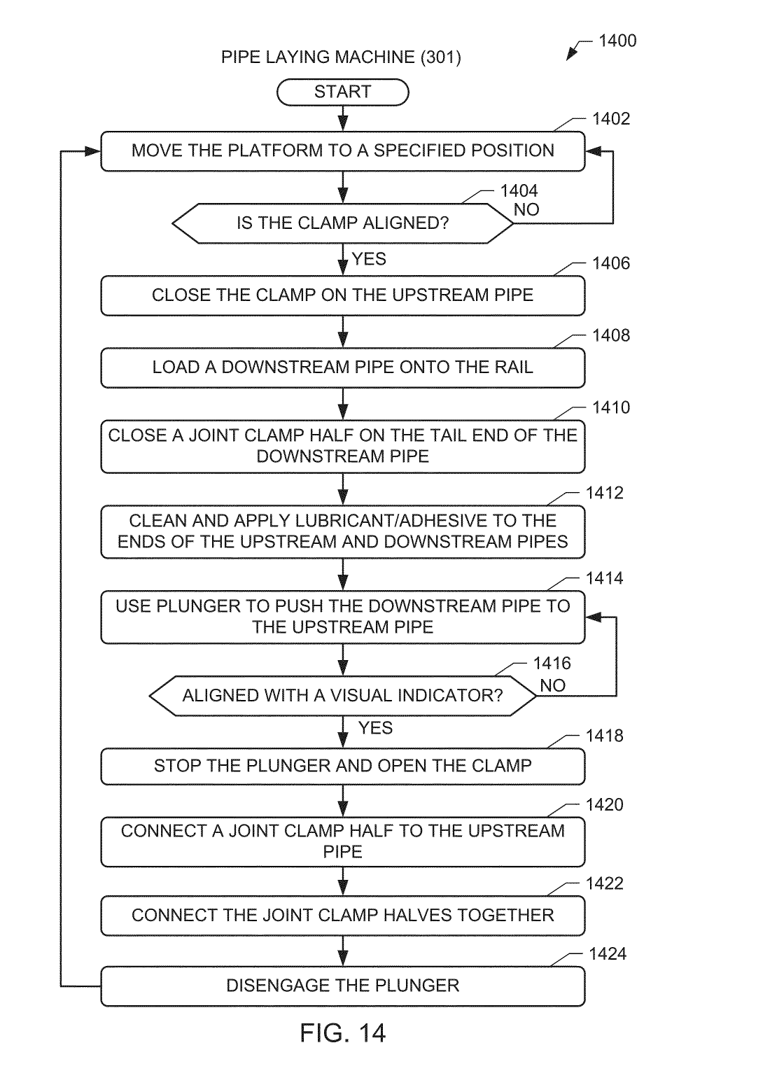

FIG. 14 illustrates a flow diagram showing an example procedure 1400 to connect and lay irrigation pipe, according to an example embodiment of the present disclosure. Although the procedure 1400 is described with reference to the flow diagram illustrated in FIG. 14, it should be appreciated that many other methods of performing the steps associated with the procedure 1400 may be used. For example, the order of many of the blocks may be changed, certain blocks may be combined with other blocks, and some of the blocks described are optional (e.g., blocks 1412, 1410, 1420, and 1422). Further, the actions described in procedure 1400 may be performed among multiple components of the pipe laying machine 301 including, for example the rail 316, the clamp 326, the plunger 336, the platform 302/tractor 314, and/or the controller 502.

The example procedure 1400 of FIG. 14 is discussed in conjunction with the placement of the joint clamp 1200 of FIGS. 12 and 13 on a joint of a downstream and upstream pipe. In other embodiments, the joint clamp 1200 may be omitted. The procedure 1400 begins when the pipe laying machine 301 including the platform 302 of FIGS. 3A and 5 moves into a specified position adjacent to a trench (block 1402). A check is performed to determine whether the clamp 326 of the pipe laying machine 301 is aligned with an edge of a bell mouth of a bell end of an upstream pipe (block 1404). Conditioned on the clamp 326 not being aligned, the procedure 1400 returns to block 1402 and continues moving the pipe laying machine 1402 until the clamp 326 is aligned.

However, conditioned on the clamp 326 being aligned, the clamp 326 is closed on the bell end of the upstream pipe (block 1406). During this time that the clamp 326 is closed, a downstream pipe is loaded onto the rail 316 (block 1408). The joint clamp half 1202 of FIG. 12 is closed on a spigot end of the downstream pipe adjacent to a visual indicator (block 1410). Additionally, an interior of the bell mouth of the bell end of the upstream pipe and an exterior of the spigot end of the downstream pipe are cleaned (block 1412). A lubricant and/or an adhesive is also applied to at least a portion of the spigot end of the downstream pipe.

After the upstream and downstream pipes have been prepared for connecting, the plunger 336 is engaged to push the downstream pipe toward the upstream pipe such that the spigot end of the downstream pipe is inserted into the bell mouth of the upstream pipe (block 1414). A check is performed to determine if a leading edge of the bell mouth is adjacent to or otherwise aligned with the visual indicator on the spigot end of the downstream pipe (block 1416). Conditioned on the bell mouth not being aligned, the plunger 336 continues to push the downstream pipe until there is an alignment of the bell mouth and the visual indicator (block 1414). Alternatively, the plunger 336 may push the downstream pipe into the upstream pipe until the bell mouth of the upstream pipe contacts the joint clamp half 1302 on the downstream pipe. In some of these alternative instances, a force sensor or vision system may detect when the bell mouth of the upstream pipe contacts (or becomes adjacent to) the joint clamp half 1202 on the downstream pipe.

However, conditioned on the bell mouth being aligned with the visual indicator on the downstream pipe, the plunger 336 is stopped and the clamp 326 is opened (block 1418). The joint clamp half 1204 is closed on the bell end of the upstream pipe (block 1420). The two joint clamp halves 1202 and 1204 are then connected together (block 1422). Further, the plunger 336 is disengaged and returned to the first end 504 of the track 505 of FIG. 5 (block 1424). At this point, the procedure 1400 returns to block 1402 where the pipe laying machine 301 is moved to the next downstream position. In some embodiments, the joint clamp 1200 may be removed when the irrigation pipes reach the end of the rail 316 and/or the bottom of a trench. In embodiments where the most recently connected downstream pipe is the last irrigation pipe to be connected, the procedure 1400 ends by the pipe laying machine 301 moving downstream to lay the last pipe into the trench.

### CONCLUSION

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An apparatus for laying pipe within the ground comprising:
a platform including a first end and a second end, the platform being configured to move relative to the ground;
a clamp located adjacent to the first end of the platform and configured to grip a portion of a bell end of an upstream pipe to prevent the upstream pipe from moving, a spigot end of the upstream pipe being connected to a second upstream pipe; and
a plunger located adjacent to the second end of the platform and configured to push against a face of a bell end of a downstream pipe causing a spigot end of the downstream pipe to connect to the bell end of the upstream pipe,
wherein the plunger is configured to push against the face of the bell end of the downstream pipe when the clamp grips the portion of the bell end of the upstream pipe.

2. The apparatus of claim 1, further comprising a rail having a first end positioned within the ground upstream from the platform and a second end adjacent to the second end of the platform, the rail being configured to support the upstream pipe and the downstream pipe.

3. The apparatus of claim 2, wherein the rail includes sliders configured to enable the upstream pipe and the downstream pipe to move relative to the rail, the sliders being positioned at periodic intervals along the rail.

4. The apparatus of claim 3, wherein the sliders are configured to be adjustable based on a diameter of the downstream pipe and the upstream pipe.

5. The apparatus of claim 2, wherein the rail is located at a side of the platform and includes an incline configured to reduce a stress and a misalignment of joints connecting adjacent pipes.

6. The apparatus of claim 1, further comprising a magazine configured to form a channel to consecutively align pipes along a width of the pipes, the magazine having a first end configured to receive the pipes and a second end configured to dispense one pipe at a time.

7. The apparatus of claim 1, further comprising a funnel connected to the first end of the magazine, the funnel configured to align pipes for loading into the magazine with the channel.

8. The apparatus of claim 1, wherein the upstream pipe and the downstream pipe have a diameter between 6 inches and 27 inches.

9. The apparatus of claim 1, wherein the bell end of the upstream pipe includes a bell mouth and the spigot end of the downstream pipe includes an elastomeric radial seal.

10. The apparatus of claim 9, wherein the clamp is configured to grip the portion of the bell end at a first side of the bell mouth.

11. The apparatus of claim 9, wherein the plunger is configured to push the spigot end the downstream pipe into the bell mouth of the upstream pipe causing the elastomeric radial seal to engage the spigot end the downstream pipe.

12. The apparatus of claim 1, wherein the clamp includes a first clamp configured to grip a first portion of the end portion and a second clamp configured to grip a second portion of the end portion, the first and second clamps being configured to operate cooperatively to grip the end portion of the upstream pipe.

13. The apparatus of claim 1, further comprising a plunger stop located to prevent the plunger from over inserting the spigot end of the downstream pipe into the bell end of the upstream pipe.

14. A method for laying pipe within ground comprising:
moving a platform to a first position adjacent to a trench, the platform including a first end and a second end, the first position corresponding to a location where a clamp is adjacent to a portion of a bell end of an upstream pipe;
closing the clamp on the end portion of the bell end of the upstream pipe to prevent movement of the upstream pipe;
conditioned on closing the clamp, moving a plunger from an initial position to push against an end face at a bell end of a downstream pipe causing a spigot end of the downstream pipe to connect to the bell end of the upstream pipe;
after making the connection, opening the clamp, returning the plunger to the initial position, and moving the platform to a second position downstream from the first position adjacent to the trench causing the upstream pipe and the downstream pipe to remain stationary relative to the ground while being lowered into the trench.

15. The method of claim 14, wherein the downstream pipe and the upstream pipe are located on a rail that is configured to gradually lower the downstream pipe and the upstream pipe into the trench such that the downstream pipe, the upstream pipe, and the connection of the downstream pipe with the upstream pipe does not exceed a predetermined angle based on an angle of incline of the rail.

16. The method of claim 14, further comprising:
receiving an indication that an end face of the bell end of the downstream pipe has reached a visual indicator located on a portion of the spigot end of the downstream pipe; and
conditioned on receiving the indication, stopping the plunger from pushing against the end face at the bell end of the downstream pipe.

17. The method of claim 14, further comprising preventing the platform from moving when the clamp is closed on the end portion of the bell end of the upstream pipe.

18. The method of claim 14, further comprising after moving the platform to the second position, enabling another downstream pipe to be placed in position for the plunger to push against an end face at a bell end of the other downstream pipe.

19. The method of claim 14, further comprising:
attaching a first joint clamp half on the bell end of the upstream pipe;
attaching a second joint clamp half on the spigot end of the downstream pipe adjacent to a visual indicator, the placement of the second joint clamp half preventing the spigot end of the downstream pipe from being over-inserted into the bell end of the upstream pipe;
connecting the first joint clamp half to the second joint clamp half forming a joint clamp; and
removing the joint clamp from the downstream pipe and the upstream pipe after the downstream pipe and the upstream pipe have reached the bottom of the trench.

20. The method of claim 19, wherein the first joint clamp is attached to the bell end of the upstream pipe after the clamp is opened from gripping the bell end of the upstream pipe.

21. The method of claim 19, further comprising:
returning the joint clamp to the platform; and
disconnecting the first joint clamp half from the second joint clamp half.

22. An apparatus comprising:
a first clamp configured to contact an end portion of an upstream pipe;
a second clamp configured to contact an end portion of a downstream pipe, the end portion of the downstream pipe being connected to the end portion of the upstream pipe;
a connector section including a first end connected to either the first clamp or the second clamp and a second end removeably connected to the other of the first clamp and the second clamp.

23. The apparatus of claim 22, wherein the end portion of the downstream pipe includes a visual indicator and the second clamp is positioned adjacent to the visual indicator to prevent the end portion of the downstream pipe from being over-inserted into the end portion of the upstream pipe.

24. The apparatus of claim 22, wherein connection of the first clamp with the second clamp reinforces the connection between the upstream pipe and the downstream pipe while the downstream pipe and the upstream pipe are being lowered in a trench.

25. The apparatus of claim 22, wherein the reinforced connection reduces stress and improves alignment of between the upstream pipe and the downstream pipe.

26. The apparatus of claim 22, wherein the first clamp or the second clamp removeably connected to the connector section includes a connection tab and the connection section includes a cutout that enables the connection tab to engage the cutout.

27. The apparatus of claim 26, further comprising a lockout key that is removeably connected to the tab such that the connector section is securely connected to the first clamp or the second clamp when the lockout key is connected to the tab.
